(19) United States
(12) Patent Application Publication
(10) Pub. No.: US 2026/0261105 A1
(43) Pub. Date: Sep. 3, 2026

(54) Cable Organizing Device & System

(71) Applicant: Michael D. McCarthy, New Holstein, WI (US)

(72) Inventor: Michael D. McCarthy, New Holstein, WI (US)

(21) Appl. No.: 19/068,555

(22) Filed: Mar. 3, 2025

(51) Int. Cl. H02G 3/32

(52) U.S. Cl. CPC H02G 3/32

(57) ABSTRACT

The invention herein pertains to a system and device that routes a plurality of wires by coupling each wire separately within a yoke-like device that is noise absorbant and guiding each said wire along a predetermined path in a separated, organized, lifted, and parallel manner. The benefits of this invention include improved transmittal of electrical and radio signals, reduced electrical interference and distortion resulting from said interference, improved organization of wire systems, and improved visual appeal of the user space.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### CROSS-REFERENCE TO RELATED APPLICATIONS

This nonprovisional utility patent application claims benefit to and incorporates by reference the prior filed provisional patent application, Application No. 63575072, with a filing date of Apr. 5, 2024, in accordance with 35 U.S.C. 120, 37 C.F.R. 1.53(b) and all other relevant law not otherwise referenced herein.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

### Field of the Invention

The invention herein pertains to a system and device for guiding and coupling electrical wires together along a preconceived locational path in an organized and parallel manner.

### Background

High-fidelity (hi-fi) sound is a high-quality reproduction of sound that is accurate and clear. Hi-fi audio is designed to mimic the original recording with minimal distortion and a full range of audible frequencies. The attainment of high-fidelity sound is a passion and preoccupation of many audiophiles and home audio enthusiasts. High-fidelity systems and equipment aim to facilitate sound reproduction without audible noise or distortions within human hearing range.

In the 1960s, the FTC with the help of the audio manufacturers defined a new industry category and standard relating to high-fidelity equipment. Stereophonic sound technology was one early improvement within this industry that enabled the separation of reproduced sound among instruments. Stereophonic sound output creates an audio-spatial illusion that is referred to as a phantom central channel. A phantom center channel is a psychoacoustic phenomenon that creates the illusion of a sound source coming from a point between two speakers. It is achieved when the same sound is heard in both ears simultaneously and with equal intensity. Quadrophonic sound technology has been another improvement within the industry. Quadraphonic sound (also referrable to as “surround sound”) uses four audio channels in which speakers are positioned at the four corners of a listening space and where reproduced sound signals are independent of each other. Quadrophonic surround sound recreates the highly realistic effect of a three-dimensional live concert hall experience in an intimate setting. It enhances the listener's experience beyond a stereophonic sound effect. Hi-fi systems continue to improve and expand, now with systems that can achieve six to eight-channel sound outputs.

In addition to achieving a reproduced experience of spatial realism, the playback of music from these systems must be subjectively free from noise, such as hisses and hums. Audio equipment must reproduce sufficiently high and low levels of sound frequencies to achieve the desired realistic effect. The equipment must further be free of noticeable signal distortions that would otherwise detract from the illusion of a live or true-to-life sound experience.

Electrical interference in a HiFi system can be a silent saboteur to quality sound reproduction. This nuisance can greatly affect the overall sound quality, introducing noise and distortion to an otherwise flawless audio experience. Interference can stem from various internal and external sources, including household appliances, wireless devices, and even the components within the audio system. Overlapping wires may interfere with the fluid transmission of electrical signals.

Common types of interference include radio frequency (RF) and electromagnetic interference (EMI). While both degrade the system's performance, RF affects wireless signals and EMI induces unwanted currents in cables and equipment.

These disruptive energies manifest in multiple ways from a slight hum to a pervasive 1 buzz. Other tools and components electrically connected to the system become an added source of noise if not properly grounded or shielded. Impacts on conductivity within the wired system may also add to the overall distortion effect.

To shield a HiFi system from electrical interference, cables must be properly organized and routed. Routing audio cables away from power cords and avoiding their physical overlap significantly reduces interference.

The problem of having lengthy multitudes of conduits can be a true hazard within certain industries, such as medicine. In a hospital setting, electrical wires and catheters connect the patient to machines and move around the patient during procedure and care. Solutions that have been developed in the arena of wire placement devices are focused on improving industry standards. For example, U.S. Pat. No. 9,746,052 introduces a wire harnessing system that holds together a set of conduits and maintains their relative position along a linear pathway. This device and system solely address the issue of placement. Electrical wires will overlap within the device and system of U.S. Pat. No. '052 whereby transmission interference remains unaddressed.

U.S. Pat. No. 6,375,017 improves upon U.S. Pat. No. '052 by providing additional guides and separation for the multitudes of medical tubes used in a hospital patient care setting. The separation of tubes eliminates their likely entanglement, allowing nurses and doctors to quickly and accurately manage their administered care. However, as discussed above, this only addresses an organizational issue. The harnesses in direct contact with the wires can become conducting features, adding to and compounding the RF and EMI problem that is a concern in the audio industry but not medicine. There remains a need for a way to dually organize wires to facilitate their fluid conduction of electrical and radio signals while helping to minimize and without adding to the interference.

### SUMMARY OF INVENTION

The invention herein pertains to a system and device that dually separates a plurality of wires while minimizing radio frequency (“RF”) and electromagnetic interference (“EMI”) noise transmission among the wires when held on the device. The system and device of this invention aim to separate wires individually within a yoke-like device and guide them along a predetermined path lifted above ground. The system enables the strategic positioning of wires in a parallel manner along a linear path to facilitate a straight and fluid transmission of signals therethrough. The straightness of the wires (with minimal sagging or bends) encourages a direct and steady signal flow within each electrical conduit. This invention further improves upon existing technology by providing an elastic element capable of cushioning or absorbing extraneous air wave signals and frequencies that naturally resonate or emit from electrical wires, reducing unwanted noise effect.

Reference to wire elements within this application shall be understood as an enclosed electrical conduit device and system that provides a linear pathway and connection points for channeling electrical, digital, or radio signals, or a combination thereof. The word “wire” may be used interchangeably with the words “cable, cord, line, or conduit” each of which broadly comprise the same types of components and functions.

The device and system of this invention comprises the following features and elements. The system of this invention is comprised of one or more devices of this invention used in a tandem manner. The device of this invention comprises a yoke unit. Said yoke unit comprises a first preferred embodiment and other alternative embodiments. The various embodiments of said yoke unit contain removably connectable parts that are interchangeable between each alternative embodiment. Each yoke unit contains the following elements: one or more plates, a base element, a neck element, and at least one elastic cushion element in physical contact with one or more of the described elements of the yoke unit.

Said one or more plates of said yoke unit have apertures along its perimeter edge that are each intended to hold a single wire conduit in place. The width or diameter of each aperture is preferably at least equal to the cross-sectional diameter of a single conduit wire to be held therein. According to a first preferred embodiment of the invention, said one or more plates of the yoke unit comprises two plates. The two plates are held together by a removable connection element. Said removable connection element comprises a screw, nut, and rubber gasket. Said rubber gasket of this connection element dually functions as an elastic cushion element of the invention that cushions or absorbs extraneous electrostatic or air frequency noise. The two plates of said yoke unit of this embodiment are further attachable to a base element. Said base element of this invention also contains a cushion element. Said cushion element of said base element comprises an elastic semidurable material attachable to the bottom surface of said base element. Said cushion element of said base element may comprise any organic or inorganic soft material such as foam, cork, rubber, weaved material, fibrous material, or a combination thereof. The various cushion elements of this described preferred embodiment aids in cushioning or absorbing extraneous noise emitted from the wires held thereon and therethrough.

There are alternative forms of the yoke unit. The alternative forms of said yoke unit may comprise alternatively shaped and functioning plate elements or alternatively shaped and functioning base elements. The alternative base element may be fixable to a surface in a semi-permanent manner such as by screw. This alternative form of the base element may provide a cushion element seated between said yoke element at the bottom of said base element and the fixed surface. Similarly, the cushion element of the alternative base element may comprise any organic or inorganic soft material such as foam, cork, rubber, weaved material, fibrous material, or a combination thereof.

The system of this invention comprises the following features and elements. One or more yoke units positioned at a predetermined location along a predetermined path on a surface (i.e. floor, wall, platform, etc.). One or more cable wires separately and individually sleeved through an aperture of each yoke unit along said predetermined path. Said one or more cable wires are held and suspended along said predetermined path in parallel manner with another wire held thereon in an adjacent aperture of a given yoke unit. Said one or more cable wires would not be in direct physical contact with another one or more cable wires when held and suspended within each said one or more yoke units. Said one or more cable wires are each individually in direct physical contact with said one or more yoke units when held and suspended therein.

Other features, advantages, and object of the present invention will become more apparent and be more readily understood from the following detailed description, which should be read in conjunction with the accompanying drawings.

### BRIEF DESCRIPTION OF DRAWINGS

FIG. 1 is an exemplary image of a preferred embodiment of the yoke unit as described herein.

FIG. 2 is an exemplary image of a preferred embodiment of the yoke unit in-use as described herein.

FIG. 3 is an exemplary image of a preferred embodiment of the yoke unit in-use as described herein.

FIG. 4 is an exemplary image of an alternative embodiment of the yoke unit as described herein.

FIGS. 5A and 5B are exemplary images of an alternative embodiment of the yoke unit as described herein.

FIG. 6 is an exemplary image of a preferred embodiment of the yoke system in-use as described herein.

FIG. 7 is an exemplary image of an alternative embodiment of the yoke system in-use as described herein.

FIG. 8 is an exemplary image of an alternative embodiment of the yoke system in-use as described herein.

FIG. 9 is an exemplary image of a alternative embodiment of a combined yoke system in-use as described herein.

FIGS. 10A and 10B are exemplary images of an alternative embodiment of the yoke device as described herein.

FIGS. 11A, 11B, and 11C are exemplary images of an alternative embodiment of the yoke system as described herein.

FIG. 12 is an exemplary image of an alternative embodiment of the yoke system as described herein.

### DETAILED DESCRIPTION OF THE INVENTION

Reference will now be made in detail to exemplary aspects of the present invention which are illustrated in the accompanying drawings. Wherever possible, the same reference numbers will be used throughout the drawings to refer to the same or like parts.

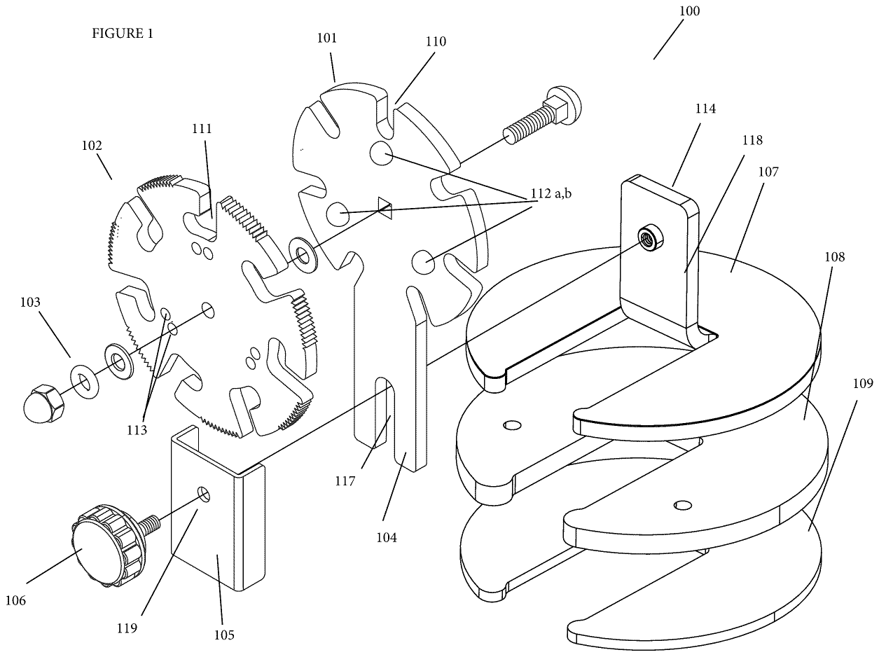

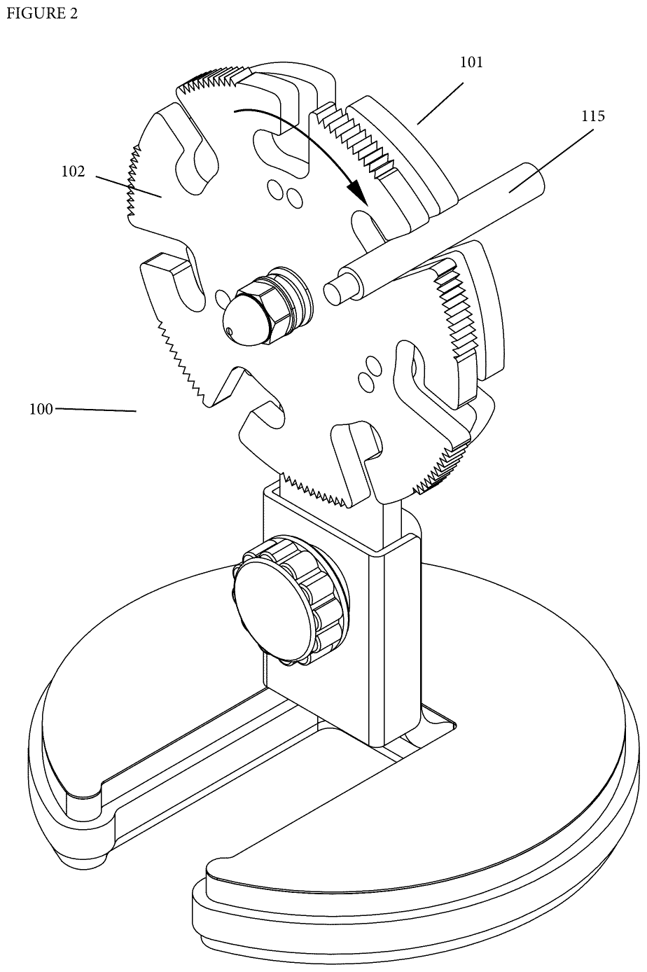

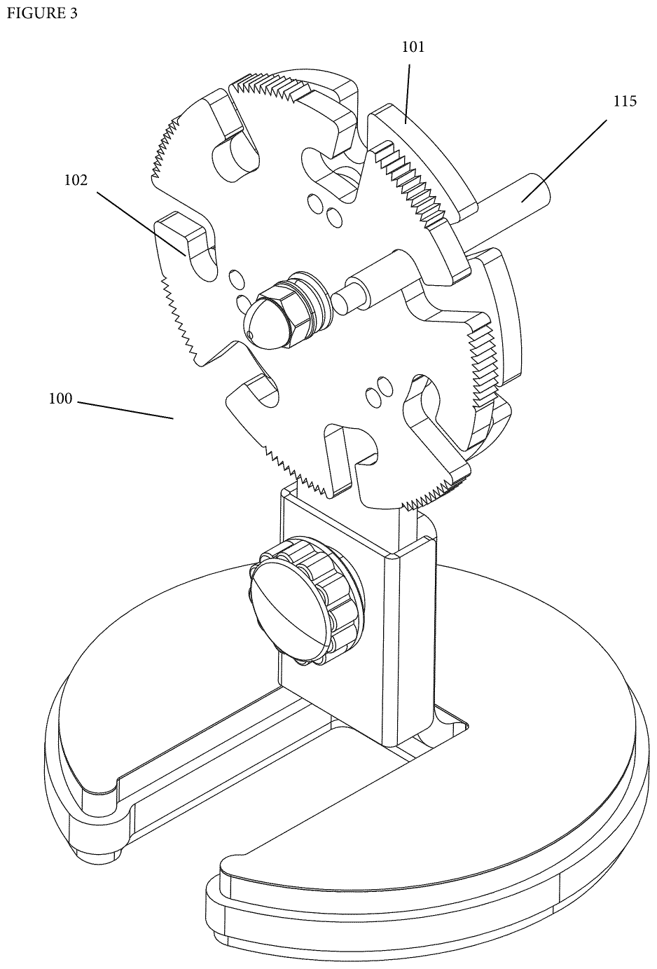

FIGS. 1, 2, and 3 provide an exemplary embodiment of a preferred embodiment of the yoke unit of this invention 100. The yoke unit 100 as illustrated in FIG. 1 provides the following elemental features. This first preferred embodiment of the yoke unit 100 comprises two matching plates 101, 102, a base element 107, and a neck element 114 extending from said base element 107. Each plate of said two matching plates 101, 102 having at least one or more apertures 111, 110 along its perimeter edge. Each of said two plates 101, 102 having a first side and second side wherein when they are positioned together, a first side of a first plate is facing a second side of a second plate. The first side of said first plate and second side of said second plate having a flat planar surface. The location of each aperture of each plate is at the same mirror location of the other when the two plates are combined in the manner described above. The shape of said one or more aperture of the first plate is not the same as the shape of the aperture of said second plate. The shape of said one or more aperture of both first and second plates are open towards and through the perimeter edge of each said plate such that each aperture is not enclosed or surrounded by the material of said plate. As shown in FIG. 2, the two plates may be positioned together in such a way that both apertures are tandemly in an open position and a wire 115 may be threaded through into both apertures at once. However, the aperture of each plate when rotated past the other plate, as illustrated in FIGS. 2 and 3, will change from an open position to a closed position where the border of either or both first or second plate will fully surround the aperture while leaving a hollow channel space. The wire 115 that was threaded through in FIG. 2 is now fully enclosed and held within said hollow channel space.

Each of said two matching plates 101, 102 of the preferred embodiment shown in FIGS. 1, 2, and 3, are centrally connectable to the other in a rotatable manner. Each of said two matching plates are rotatable from the other in a clockwise and counter-clockwise manner as illustrated in FIG. 2. Said one or more aperture 110, 111 of each plate is radially positioned at equal distance from the other. Said one or more aperture 110, 111 of each plate having the same shape on that respective plate. The shape of each said one or more apertures on said first plate having an L, C, or J shape. The shape of each said one or more apertures of said second plate having a U, C, rectangular, or square shape. The shapes of the aperture of both plates are such that an opening extends towards and through the perimeter edge of each said plate. The shape of the aperture of said first and second plates are different in such a manner that when the apertures are laid over each other (wherein said two plates are positioned facing each other in a sandwich manner), the combined effect of the two overlaid apertures results in an enclosed effect and creates a sleeve-like or yoke-like hollow channel space that is large enough to fit the diameter of a single conduit therethrough. The aperture effectively becomes a yoke, holding the cross-sectional line of said single conduit.

The central connection of said two matching plates according to the embodiment of FIGS. 1, 2, and 3, comprises an element that allows for removable connection of said two plates. Said element may comprise a nut and bolt or other known manner of removable connector. The central connection further containing a cushion element in the form of a rubber gasket 103 element or a similarly durable elastic material gasket element that surrounds and cushions the nut and bolt element when installed. This helps to create a cushioned friction seal. The rubber gasket, having an elastic quality, provides an added benefit of stabilizing the yolk unit and cushioning, deadening, or absorbing excess electro-static or air frequency noise and emissions that may be emitted from the conduits held thereon.

As shown in FIG. 1, each of the two plates 101, 102 of the first preferred embodiment having at least three sets of holes 113, 112 positioned radially and equal distant from each other between the apertures and the central connection. Each set of holes 113 on said first plate comprising two holes adjacently positioned and separately apart, following the radial curvature of each said plate. Each set of holes 112a on said second plate comprising a single hole 112a positioned apart from each other following the radial curvature of each said plate. The single hole 112a of said second plate is positioned at such a location that each of the single holes 112a match the first or second hole of said first plate when the two plates are rotated. A small round metal bead or ball bearing 112b is freely seated on the single hole 112a of said second plate. Said metal bead or ball bearing 112b having a diameter that is greater than the circumference of said single hole 112a of said second plate and greater than the circumference of the first and second holes 113 of said first plate. The metal bead or ball bearing 112a is freely seated on said single hole 112a of said second plate such that when the two plates are attached at their central connection, may rotate from the applied pressure of the bead rolling past the surface of the first plate. When the metal bead or ball bearing 112b reaches either the first or second hole 112a of the second plate and falls into an indentation on the interior surface created by said first or second hole 113, the pressure between the plates are released and the two plates lock into position. The two plates are held tightly together by the friction fit of the bead or ball bearing 112b. The bead or ball bearing 112b, being freely held between holes 113,112a of the two plates.

FIG. 1 illustrates the manner of attachment between at least one of the plates and the base element. At least one of the plates 101, 102 of said yoke unit has a linear planar extension 104 similar to the effect of a handle. A perforation 117 is centrally positioned at the bottom end of said linear planar extension 104. Each yoke unit is attachable to a base element 107 at the neck 114 of said base element 107. The neck element 114 comprises 1) a vertical planar plate 118 that is attached to the base plate 107 and extends vertically above therefrom and 2) a removably connectable second plate 105. The removably connectable second plate 105 having a perforation 119 centrally positioned therethrough. The two planar plates 105, 118 of said neck element are connectable by a threaded screw and nut element. The linear planar extension 104 of the yoke unit is positionable between the first and second planar plate element wherein a threaded screw is sleeved through the bottom central perforation 117 of said linear planar extension 104 of said yoke unit and further through the perforation 119 of the second plate of said neck element. The two sets of elements, the neck element and the yoke unit at the linear planar extension, are held together tightly in a sandwiched manner by the nut and screw element. The attachment of the linear planar extension 104 to said base element 107 at said base element may be achieve by other known means in the art besides the nut and screw means, including pneumatic means, clipping means, sliding means, etc.

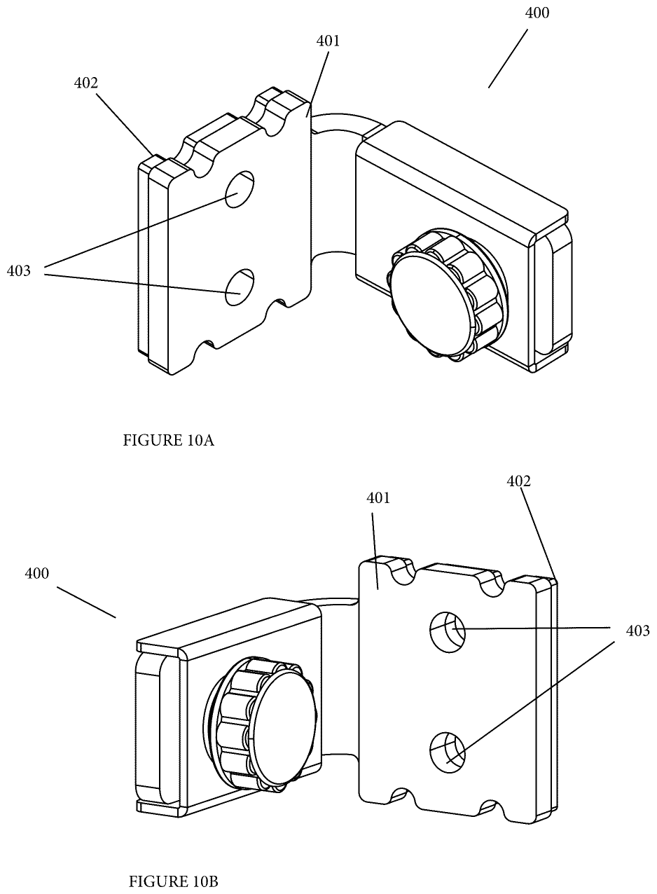

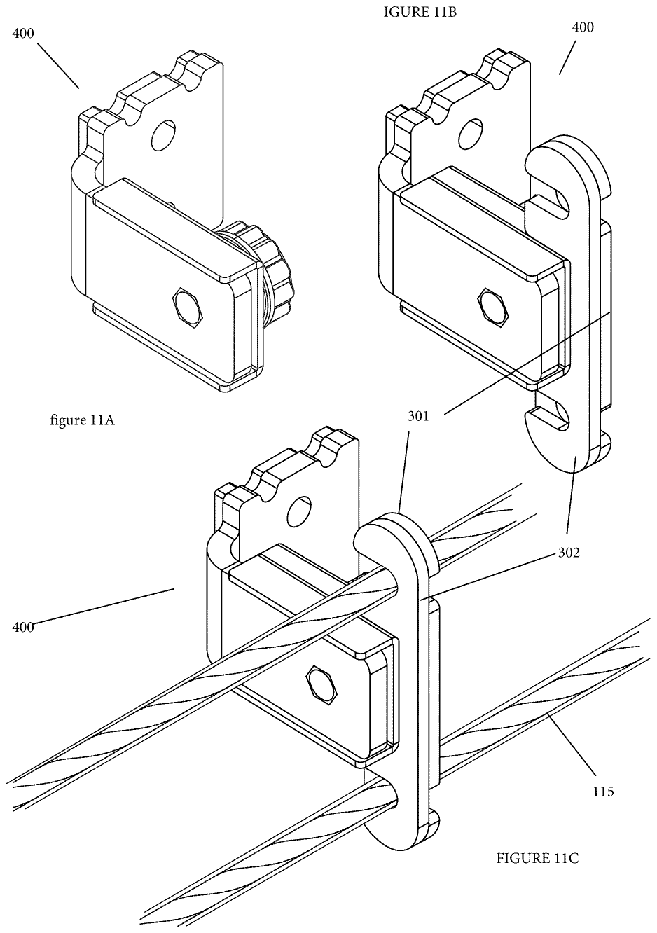

The base element 107 is a weighted element that is heavier than the combined weight of the inventive elements described above. The weight of said base element may be achieved by an additional layer of weighted material 108 therein, or alternatively comprise a single element unit comprised of heavier material 107. The base element further having a preferred base layer 109 of a soft or elastic material such as cork, plastic, or rubber that helps to further absorb excess vibrations emitted through said device of this invention. The base element may alternatively be a fixable element 400 as shown in FIGS. 10A, 10B, 11, 12 that can be affixed to a surface by semi-permanent means in the form of a fixture attachment. According to this embodiment, as shown in FIGS. 10A and 10B, a screw may be penetrated through holes 403 on said base element 400. The alternative fixable base element 400 may also have a bottom layer 402 of a soft or elastic material such as cork, plastic, or rubber that rests between said base element and its attached surface. The affixed surface may be a vertical or horizontal surface or a surface at any angular position relative to the ground. The features and function of the neck element would remain the same as described elsewhere herein, both in form and function for any base element of this invention.

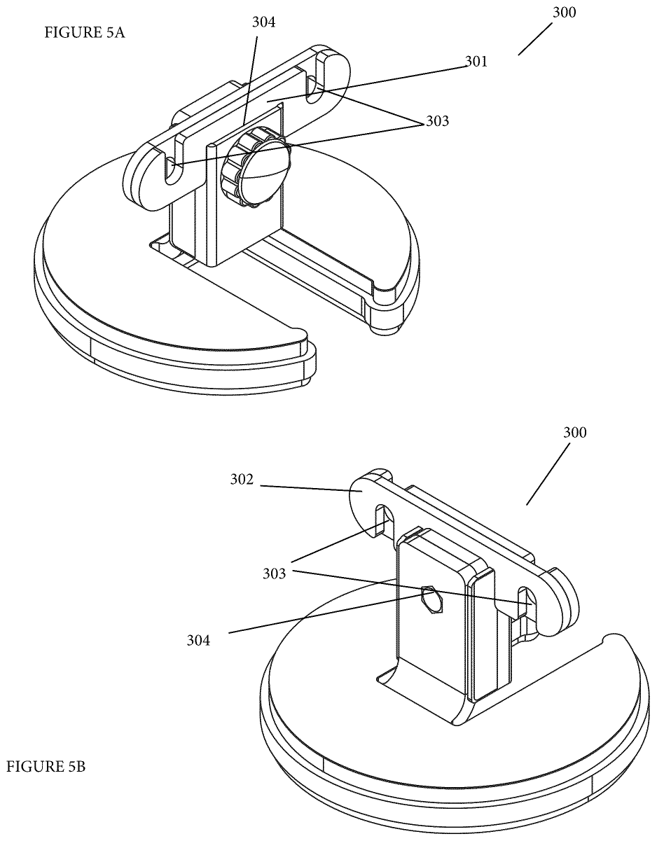

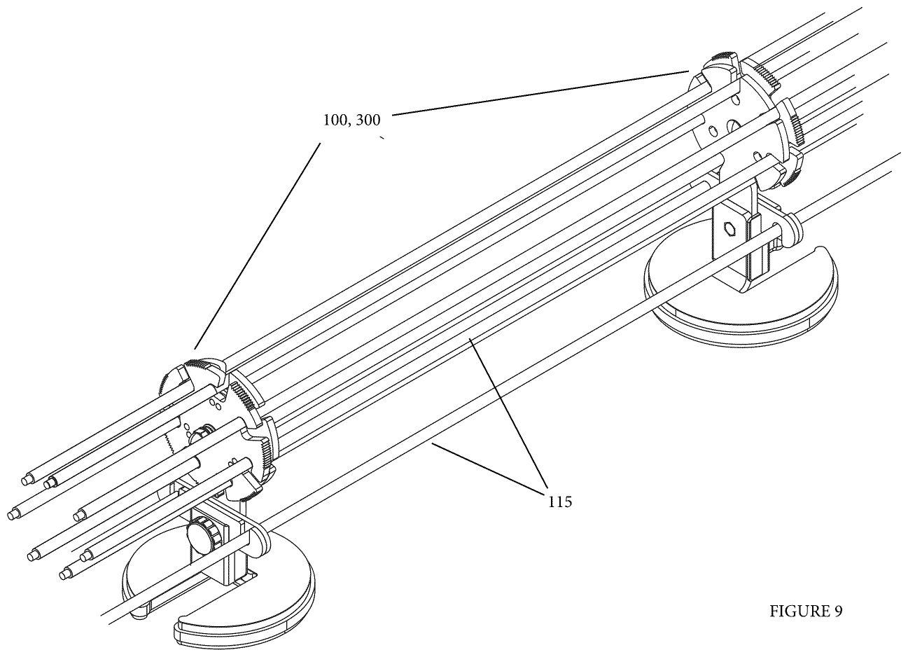

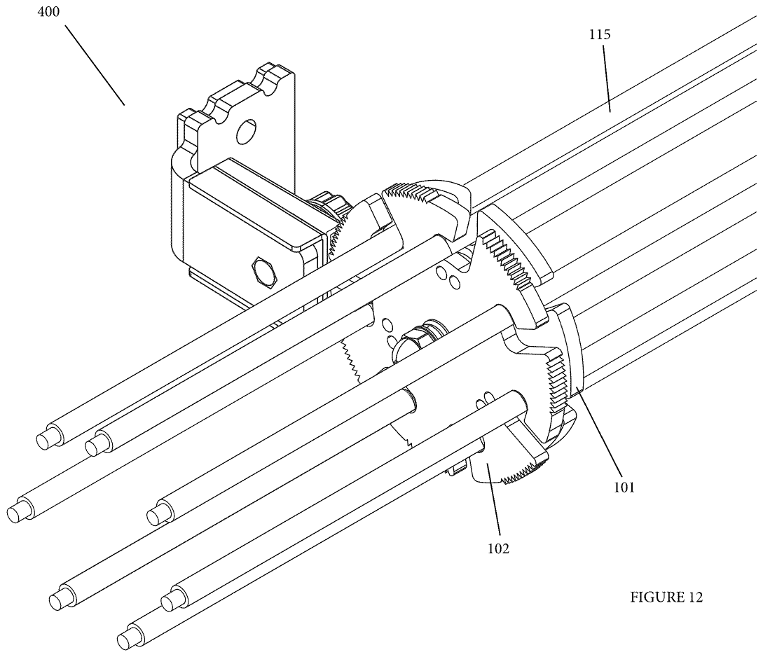

There are alternative forms of the yoke unit. The various forms of yoke units comprise interchangeable flat plates and base elements that are connectable at the neck element as shown in FIGS. 9 and 12. One or more types of planar plate elements may be combined together on a single yoke unit as shown in FIG. 9. The first form of a yoke unit has been described in detail above. A second alternative form of a yoke unit as shown in FIGS. 5A and 5B and comprises two planar plates 301, 302 of matching perimeter dimensions and matching shape. Said second alternative form of a yoke unit as shown in FIGS. 5A and 5B having a length that is greater than its width and with a perforation 304 centrally positioned through its surface. Each plate 301, 302 of said second alternative form of a yoke unit having a curved or geometric shaped aperture 303 through the top half of its surface beyond one of its perimeter edges along its length. The curved or geometric shaped aperture 303 is located equal distance from the other and equal distance away from the central perforation 304. Each of the two plates of said second alternative form of a yoke unit having a planar flat surface on its left and right sides. Said two plates 301, 302, when rotated 180 degrees from the other, and contacting each other between their each planar flat surfaces in a sandwiched manner, will result in an enclosed hollow space 303 between the two sets of reverse positioned apertures. This creates a sleeve or yoke-like hollow channel space 303. Said sleeve or yoke-like hollow channel space is at least the diameter of a conduit wire that is intended to be sleeved therethrough. The two planar plates, when positioned in reversed and sandwiched manner, may be placed between the two elements of the neck element of said base element, and connected at their said central perforation 304 to said neck and base element by said threaded screw and nut element. Other known means and known connecting elements may be used alternatively to said threaded bolt and nut element to hold tightly together the various elements (said planar plates and the neck element) in a detachably connectable way.

Said second alternative form of a yoke element may further comprise a linear planar extension 104, 203 extending from at least one of the plates similar to the effect of a handle. A perforation 117, 204 is centrally positioned at the bottom end of said linear planar extension. The linear planar extension is positionable between the first and second planar plates of said neck element 114 wherein a threaded screw is sleeved through the perforation 117, 204 of said linear planar extension and further through the perforation 119 of the second plate 105 of said neck element. The two sets of elements, the neck element and the yoke unit at the linear planar extension, are held together tightly in a sandwiched manner by the nut and screw element or other known elements or means for a removable tight connection.

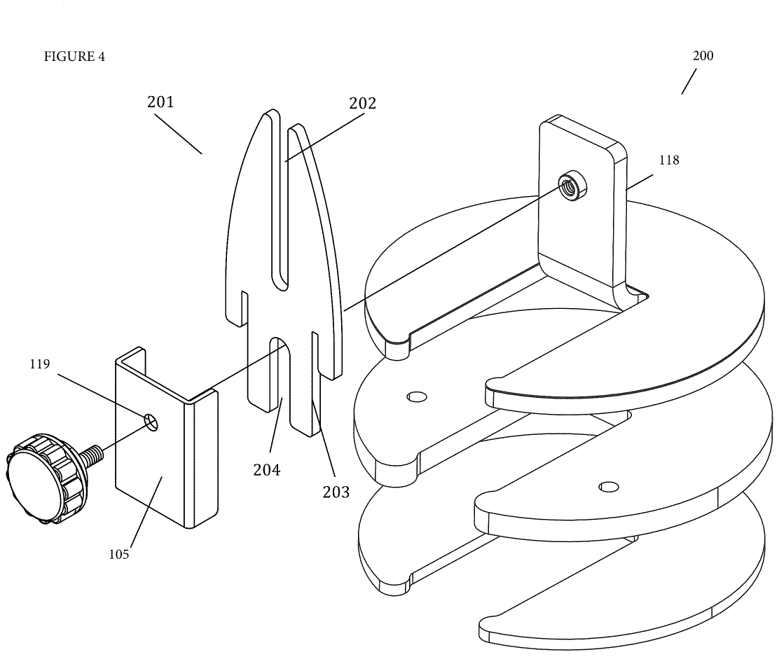

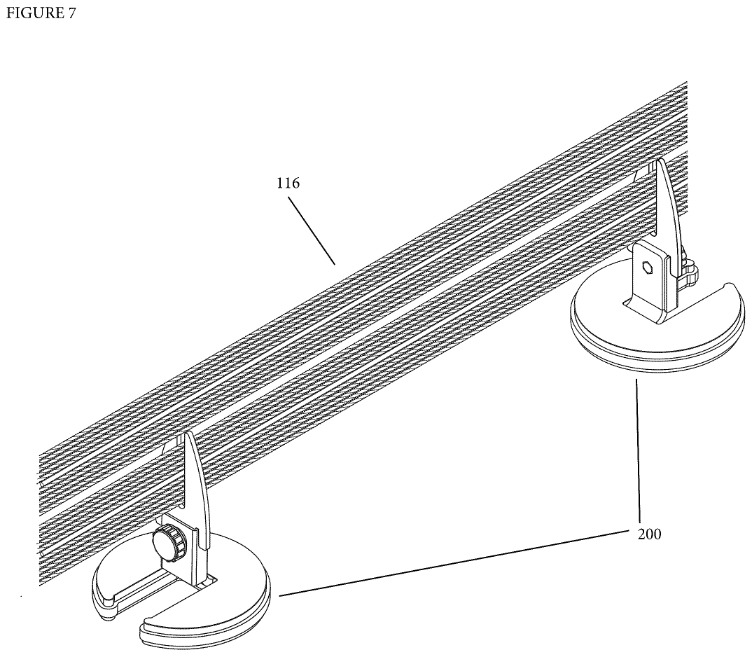

A third alternative form of a yoke unit as shown in FIG. 4 comprises a single plate 201. Said single plate 201 having two opposing flat surfaces. Said single plate having at least one or more vertical, linear, and narrow aperture 202. The narrow space and vertical length of each said aperture 202 is sufficiently great enough to hold and maintain a flat wire therein in a straight and vertical manner as shown in FIG. 7. Said third alternative form of a yoke unit as shown in FIG. 4 further comprises a linear planar extension 203 extending from its single plate 201 similar to the effect of a handle. A perforation 204 is centrally positioned at the bottom end of said linear planar extension 203. The linear planar extension 203 is positionable between the first 118 and second 105 planar plates of said neck element wherein a threaded screw is sleeved through the aperture 202 of said linear planar extension and further through the perforation 119 of the second plate 105 of said neck element. The two sets of elements, the neck element and the yoke unit at the linear planar extension, are held together tightly in a sandwiched manner by the nut and screw element or by other known elements or means for a removable tight connection.

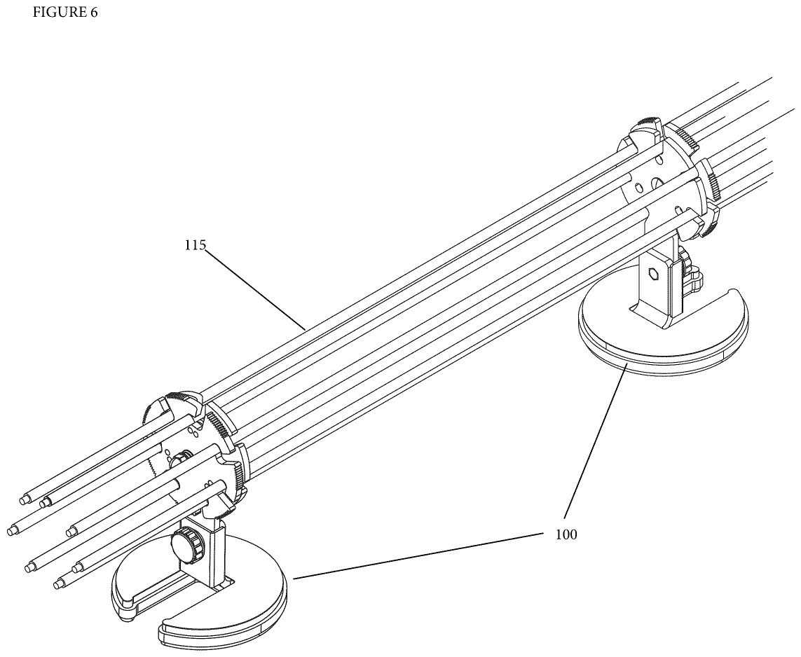

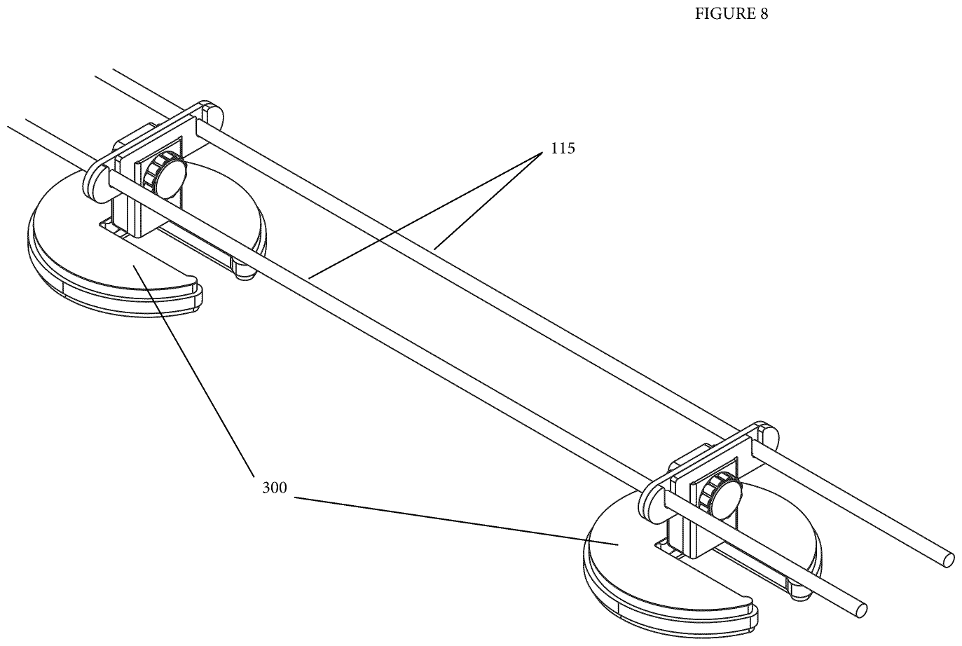

The system of this invention comprises the following features and elements. One or more yoke units positioned at a predetermined location along a predetermined path on a surface (i.e. floor, wall, platform, etc.). See FIGS. 6, 7, 8, 9. One or more cable wires separately and individually sleeved through an aperture of each yoke unit along said predetermined path. Said one or more cable wires are held and suspended along said predetermined path in parallel manner as shown in FIGS. 6, 7, 8 9. Said one or more cable wires would not be in direct physical contact with another one or more cable wires when held and suspended within each said one or more yoke units. Said one or more cable wires are each individually in direct physical contact with said one or more yoke units when held and suspended therein.

Having fully described at least one embodiment of the present invention, other equivalent or alternative methods according to the present invention will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

1: A cable organizing device comprising a yoke unit, wherein said yoke unit comprising:
one or more plates, a base element, a neck element, and at least one elastic cushion element in contact with anyone of the aforementioned elements or a combination of said aforementioned elements,
said one or more plates of said yoke unit have apertures along its perimeter edge that are each intended to hold a single wire conduit in place,
the width or diameter of each aperture is preferably at least equal to the cross-sectional diameter of a single conduit wire to be held therein,
said one or more plate is removably attachable to said base element at the neck element of said base element,
said base element containing a cushion element.

2: A cable organizing device of claim 1 wherein said base element having a weight equal or greater than the total combined weight of the other elements of said yoke unit.

3: A cable organizing device of claim 1 wherein said base element is fixable to a surface in a detachable semi-permanent manner.

4: A cable organizing device of claim 1 wherein said one or more plates is combined with a cushion element at said neck element of said base element in a removably attachable manner.

5: A cable organizing device of claim 1 wherein said yoke unit comprises a first and second plate, a first side of said first plate and a second side of said second plate having a flat planar surface, the location of each aperture of each plate is at the same mirror location of the other when the two plates are combined in the manner described above, the shape of said one or more aperture of the first plate is not the same as the shape of the aperture of said second plate, the shape of said one or more aperture of both first and second plates are open towards and through the perimeter edge of each said plate such that each aperture is not enclosed or surrounded by the material of said plate, the aperture of each plate when rotated past the other plate will change from an open position to a closed position where the border of either or both first or second plate will fully surround the aperture while leaving a hollow channel space.

6: Said first and second plates of claim 5 are held in place between their rotated position by pressure of one or more ball bearings seated between said two plates.

7: A cable organizing system comprising one or more yoke units of claim 1, wherein said one or more yoke units are positioned at a predetermined location along a predetermined path on a surface,
one or more cable wires separately and individually sleeved through an aperture of each said one or more yoke units along said predetermined path,
said one or more cable wires are held and suspended along said predetermined path in parallel manner,
said one or more cable wires not in direct physical contact with another one or more cable wires when held and suspended within each said one or more yoke units,
said one or more cable wires are each individually in direct physical contact with said one or more yoke units when held and suspended therein.
